(19) United States
(12) Patent Application Publication
(10) Pub. No.: US 2007/0174298 A1
(43) Pub. Date: Jul. 26, 2007

(54) Communication device

(75) Inventor: Yoshifumi Tanimoto, Fushimi-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/647,134

(22) Filed: Dec. 29, 2006

(30) Foreign Application Priority Data
Jan. 26, 2006 (JP) 2006-017521

(51) Int. Cl. G06F 17/30

(52) U.S. Cl. 707/10

(57) ABSTRACT

A digital MFP accesses a web server registered in a first routine site table, and acquires RSS data. The digital MFP creates an updated content database based on the acquired RSS data. From the web server, the digital MFP downloads content including a set search keyword among updated information of contents included in the RSS data. Then, the downloaded content is stored into a content database. Alternatively, the downloaded content is printed out from a printer unit. Users in an office access the digital MFP to refer to the downloaded content, and efficiently share information.

### BACKGROUND OF THE INVENTION

1. Field of the Invention

The present invention relates to technology for gathering and managing information transmitted by a website.

2. Description of the Related Art

The Resource Description Framework (RDF) Site Summary (RSS) data is used as a method for providing updated information of a website. The RSS is a structured document format for describing the updated information of the website. A user uses application software known as an RSS reader to acquire RSS data from a registered website and to easily and promptly acquire updated information of the registered website.

For example, a user registers a website, which distributes news, with an RSS reader. Accordingly, the user can promptly check the latest news at all times. Alternatively, the user may register a plurality of interesting websites with the RSS reader. Accordingly, the user is not required to access each of the websites each time to confirm whether or not each of the websites has been updated. The user can acquire updated information of favorite websites at once.

In the case of an office where a plurality of users access websites, each individual gathers and manages information. When finding interesting news, each individual downloads the news, and prints out the downloaded news according to necessity. Therefore, several persons may print out similar news. This decreases inefficient in an office, and also a waste of resources. Moreover, only a person who has noticed important information may refer to such news, and other persons may not refer to the news. As described above, information is not transmitted and shared efficiently.

By using the RSS data as described above, the user can efficiently acquire updated information of a registered website. However, even in this case, if each individual acquires the updated information, and each individual acquires and manages content, or each individual prints out and stores the content, the above-described problems also generate.

### SUMMARY OF THE INVENTION

In order to overcome the problems described above, preferred embodiments of the present invention provide technology for enabling information to be efficiently transmitted and shared among a plurality of users.

According to an aspect of the present invention, a communication device is connected to a network, and shared among a plurality of users. The communication device accesses a site database, which includes a registration of a Uniform Resource Locator (URL) of a website to be executed with routine and a routine timing, and accesses the website under the routine timing registered in the site database. The communication device acquires updated information data in which updated information of content of the website is described. The communication device extracts information relating to an updated content of the website from the updated information data, and creates an updated content database.

The communication device registers a keyword in the site database. The communication device refers to the updated content database and the keyword, and searches information including the keyword from the updated content database. Then, the communication device automatically downloads content, which is a data source of the information.

The communication device registers a process in the site database, and processes the automatically downloaded content according to the process registered in the site database.

The communication device registers a data type of data to be downloaded in the site database. Among data constituting content, the communication device registers only data corresponding to the registered data type.

The communication device registers a saving format of content to be downloaded in the site database. The communication device stores the downloaded content under the registered saving format.

Regarding information registered in the updated content database, the communication device can make a setting as to whether or not content of the information has already been downloaded.

The communication device can also make a setting as to whether or not to redownload the already downloaded content. When it is set to not redownload, the communication device uses the cached content.

The updated information data is created under an RSS format.

The communication device displays a list of information registered with the updated content database. A user selects desired information from the displayed information. In response to the selection made by the user, the communication device outputs a content of the selected information.

According to another aspect of the present invention, a communication device is connected to a network, and shared among a plurality of users. The communication device accesses a site database, which includes a registration of a URL of a website to be executed with routine and a routine timing, and accesses the website under the routine timing registered with the site database. The communication device acquires updated information data in which updated information of a content of the website is described. Then, the communication device creates a headline of updated content of the website from the updated information data, and displays the headline on a monitor in real-time.

Under a state in which the headline is displayed on the monitor, a user designates to download content, which is a data source of the headline. Then, in response to the designation made by the user, the communication device downloads the content of the displayed headline.

The communication device accesses the website under the routine timing registered with the site database, and acquires the updated information data. The communication device extracts information relating to the updated content of the website from the updated information data, and creates the updated content database. Accordingly, the updated information of the web server is managed in the communication device shared among users, and the users can efficiently share information.

Since a keyword is registered with the site database, and the content including the keyword is automatically downloaded, the users are not required to perform a work for gathering information. As a result, a work efficiency improves.

The communication device accesses the website under the update timing registered with the site database, and acquires the updated information data. Then, the communication device creates a headline of the updated content of the website from the updated information data, and displays the headline on the monitor in real-time. Accordingly, the updated information of the web server is notified to the communication device shared among users, and the users can promptly and efficiently share information.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a system configuration in an office where a digital Multi Function Peripheral (MFP) is connected to a Local Area Network (LAN) and outside of the office.

FIG. 2 is a functional block diagram of the digital MFP.

FIG. 3 illustrates an example of a first routine site table.

FIG. 4 illustrates an example of an updated content table created based on acquired RSS data.

FIG. 5 illustrates an example of a second routine site table.

FIG. 6 illustrates an example of a setting file.

FIG. 7 illustrates an index of updated content information displayed on a monitor.

FIG. 8 illustrates updated content information displayed as a headline in the monitor.

### DETAILED DESCRIPTION OF PREFERRED EMBODIMENTS

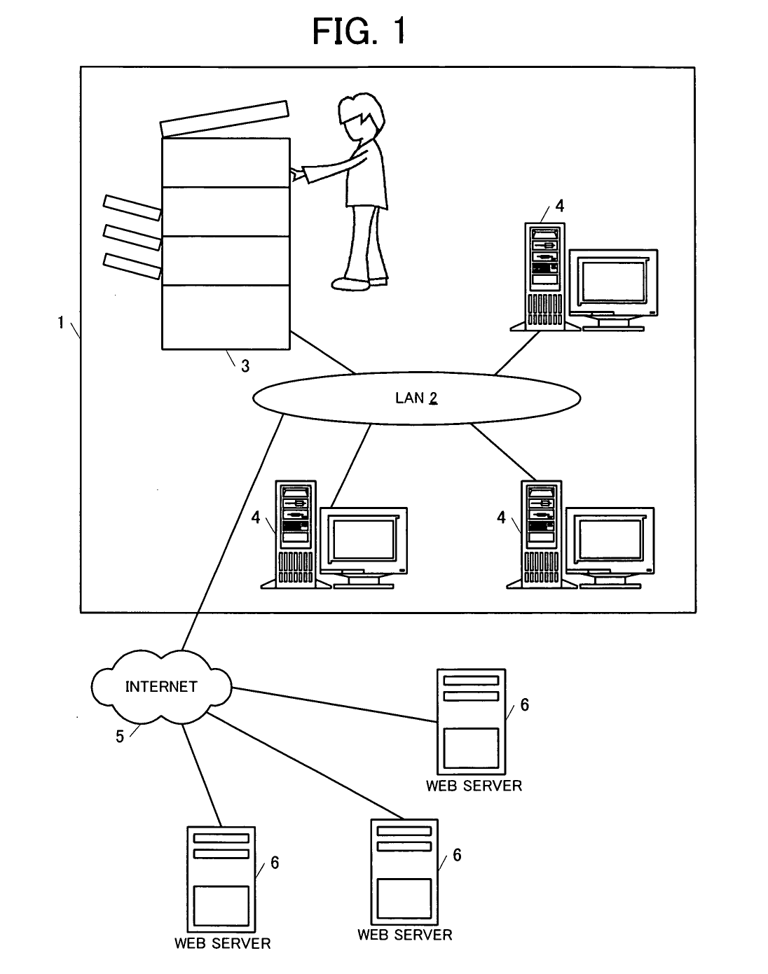

A description will be made of preferred embodiments of the present invention with reference to the drawings. In a present preferred embodiment, a description will be made of a digital MFP 3 as an example of a communication device. FIG. 1 illustrates a system configuration in an office 1 where the digital MFP 3 is located, and a system configuration outside of the office 1.

The digital MFP 3 and a plurality of Personal Computers (PCs) 4 and 4, etc. are connected to a LAN 2 built in the office 1. The LAN 2 is connected to the Internet 5 via a router or the like. A plurality of web servers 6 and 6, etc. are connected to the Internet 5. The web servers 6 and 6, etc. function as a website that distributes web contents to a terminal connected to the Internet. In the present preferred embodiment, each web server 6 distributes updated information of a website by using RSS format data.

The digital MFP 3 includes a plurality of functions in one machine. The digital MFP 3 includes a fax function, a copy function, a printer function, and a scanner function or the like, and also a network function. Therefore, the PCs 4 connected to the LAN 2 can use various functions of the digital MFP 3 via the LAN 2. An employee working in the office 1 uses the PC 4 to use the digital MFP 3 via the LAN 2. Alternatively, an employee moves to the digital MFP 3 for a copy operation or the like. One digital MFP 3 is shared among a plurality of employees.

As described above, the digital MFP 3 has been used conventionally for various works in the office 1. In the present preferred embodiment, the digital MFP 3 is used for a purpose of managing updated contents of websites. Specifically, by acquiring RSS data from a registered website, the digital MFP 3 grasps an updated status of a content of the registered website, and browses updated information and/or executes a process with respect to the updated content.

Further, the RSS data is updated information data distributed by the web servers 6 connected to the Internet 5. Updated information of the contents distributed by the web servers 6 is described in the RSS data. Specifically, when there are a plurality of contents that have been updated by the web servers 6, information such as a title, a link, a summary, and updated date and time or the like of the plurality of the updated contents are described in the RSS data. For example, when the web server 6 is a news site, for a plurality of news that have been updated in such a news site, a title of the news, a link (URL) to news contents, and a summary of the news or the like are described in the RSS data. The RSS is a standard of a structured document. There are various versions of the RSS. The RSS 1.0 is the most popular version in Japan. The RSS is generally recognized as the RDF Site Summary. The RDF is an abbreviation of the Resource Description Framework.

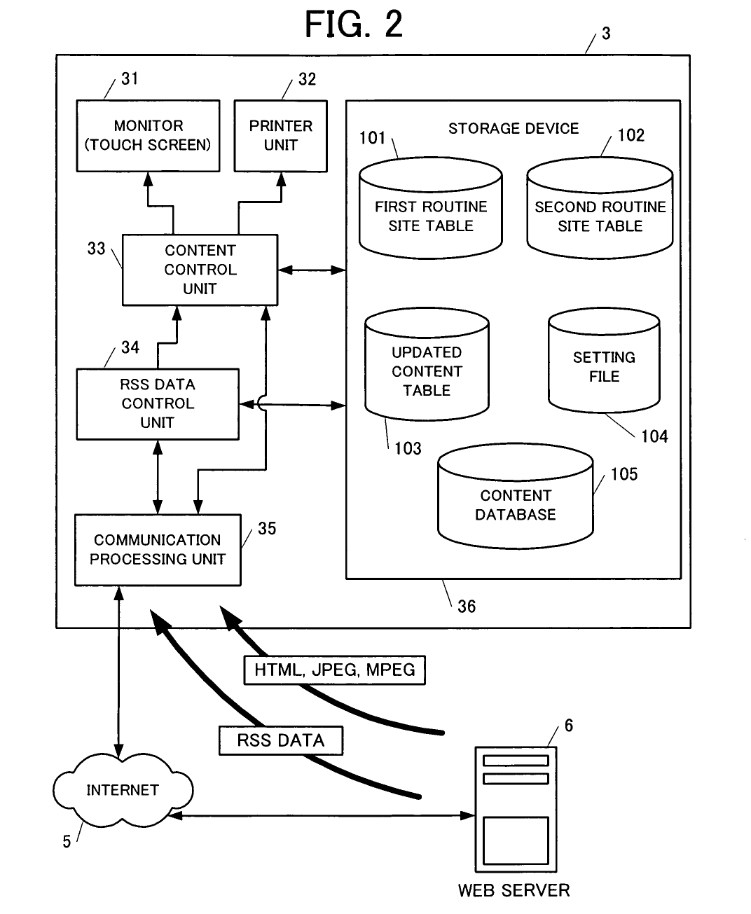

FIG. 2 is a block diagram of the digital MFP 3. FIG. 2 illustrates only blocks relating to processes according to a preferred embodiment of the present invention. Thus, processing blocks relating to the fax function, the copy function, and the scanner function or the like of the digital MFP 3 are not illustrated.

The digital MFP 3 includes a monitor 31, a printer unit 32, a content control unit 33, an RSS data control unit 34, a communication processing unit 35, and a storage device 36.

The monitor 31 is arranged at a front portion of the digital MFP 3. In the present preferred embodiment, the monitor 31 is a touch screen display, and includes a function as an entry operation unit. An employee working in the office 1 operates the monitor 31 to carry out a copy setting, and a fax transmission setting or the like. In the present preferred embodiment, the monitor 31 is used for displaying a headline news as described hereinafter.

The printer unit 32 receives a print instruction from the PC 4, and prints out various data. In the present preferred embodiment, as described hereinafter, the printer unit 32 is used for printing out updated contents of websites.

The content control unit 33 executes a process for downloading contents from the web servers 6, and executes a process on acquired contents by a registered processing method. The RSS data control unit 34 acquires RSS data from the registered web server 6. The RSS data control unit 34 extracts information relating to updated contents from the acquired RSS data, and creates an updated content table 103.

The communication processing unit 35 transmits and receives data with the PCs 4 connected to the LAN 2, and the web servers 6 connected to the Internet 5.

The storage device 36 stores a first routine site table 101, a second routine site table 102, an updated contents table 103, a setting file 104, and a content database 105.

In the first routine site table 101 and the second routine site table 102, web servers of which the digital MFP 3 executes routine to acquire RSS data are registered. The first routine site table 101 is used for providing updated information of contents in an index format. The second routine site table 102 is used for providing updated information of contents in a headline format.

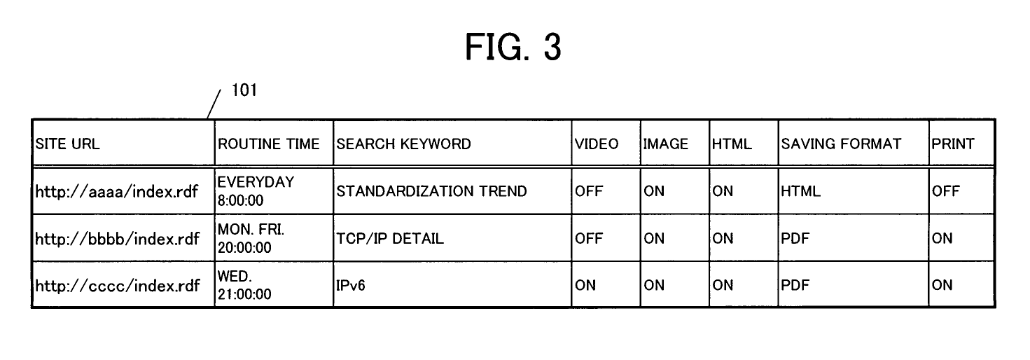

FIG. 3 illustrates the first routine site table 101. The first routine site table 101 includes setting of “SITE URL”, “ROUTINE TIME”, “SEARCH KEYWORD”, “VIDEO”, “IMAGE”, “HTML”, “SAVING FORMAT”, and “PRINT”.

“SITE URL” stores a setting of a URL of the web servers 6 that are distributing the RSS data. Specifically, URLs where the web servers 6 store the RSS data are set in “SITE URL”. “ROUTINE TIME” stores a setting of a timing when the digital MFP 3 accesses the web server for acquiring the RSS data. “SEARCH KEYWORD” stores a setting of character strings used for deciding which content to download. “VIDEO”, “IMAGE” and “HTML” store settings as to whether or not to download each of data. “SAVING FORMAT” stores a setting of saving formats of the downloaded contents. “PRINT” stores a setting as to whether or not to print out the downloaded contents.

A description will be made of first data in FIG. 3 as an example. The web server 6 with a site URL http://aaaa/index.rdf is registered. The digital MFP 3 acquires RSS data at eight o'clock everyday from this web server 6. Then, the digital MFP 3 searches a character string included in the RSS data. In case of a presence of information including a character string “STANDARDIZATION TREND”, the digital MFP 3 downloads a content, which is a data source of such information. The digital MFP 3 downloads image data and Hyper Text Markup Language (HTML) data, but does not download video data. The digital MFP 3 stores the downloaded content under an HTML format in the storage device 36, and does not print out the downloaded content.

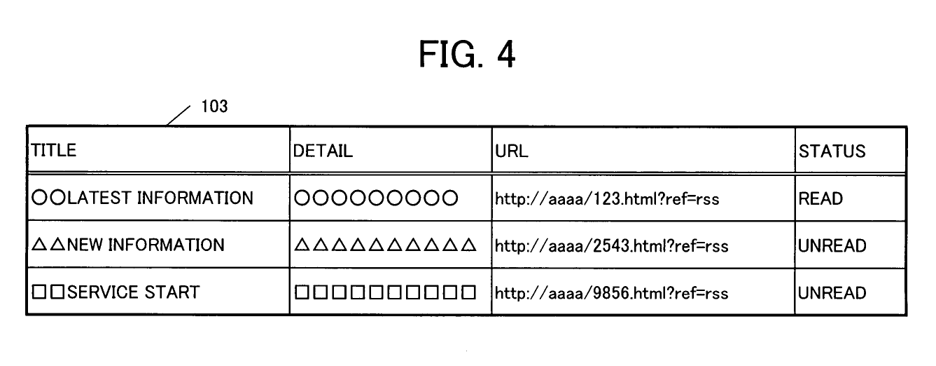

FIG. 4 illustrates the updated content table 103 created based on the acquired RSS data. The updated content table 103 is a list of information showing a summary of updated contents. For example, when the updated content table 103 is created based on RSS data distributed from a news site, the updated content table 103 is a list of information of updated news.

As illustrated in FIG. 4, the updated content table 103 includes a setting of items such as “TITLE”, “DETAIL”, “URL”, and “STATUS”. The items other than “STATUS” are extracted from the RSS data. “TITLE” stores a setting of a tile of updated contents. For example, a title of news is set. “DETAIL” stores a setting of a brief summary or the like of the contents. “URL” stores a setting of URLs as links to the contents, which are the data sources. “STATUS” stores a setting as to whether the contents, which are the data sources, are a read content or an unread content. Specifically, when a content is downloaded, “READ” is set in “STATUS”.

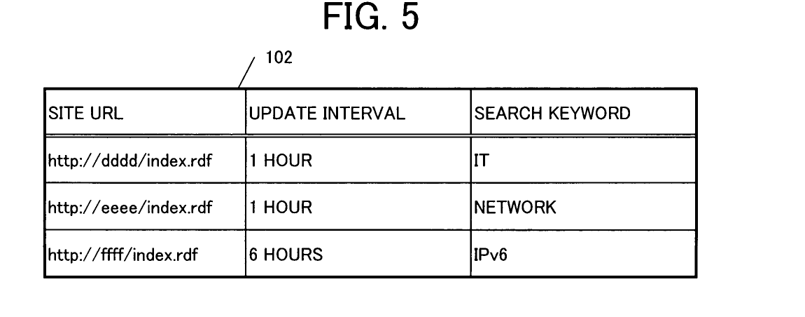

FIG. 5 illustrates the second routine site table 102. The second routine site table 102 includes a setting of items such as “SITE URL”, “UPDATE INTERVAL”, and “SEARCH KEYWORD”.

“SITE URL” stores a setting of a URL of the web servers 6 that are distributing the RSS data. “UPDATE INTERVAL” stores a setting of an update interval (routine timing) for acquiring the RSS data. “SEARCH KEYWORD” stores a setting of character strings to be used for deciding a content to be displayed as a headline.

A description will be made of first data in FIG. 5 as an example. The web server 6 with a site URL http://dddd/index.rdf is registered. The digital MFP 3 acquires RSS data from this web server 6 in a one-hour interval. The digital MFP 3 searches a character string included in the RSS data. In case of a presence of information including a character string “IT”, the digital MFP 3 creates a headline from such information, and displays the headline on the monitor 31. For example, a title of news included in the RSS data is adopted as the headline.

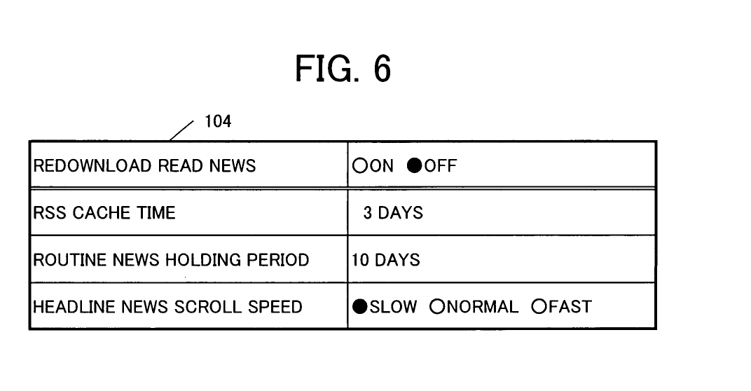

FIG. 6 illustrates the setting file 104. FIG. 6 illustrates an example in which content is news content, i.e., a processing with respect to RSS data acquired from a news site. Among setting items, “REDOWNLOAD READ NEWS” stores a setting as to whether or not to redownload news contents, which is set “READ” in the updated content table 103. When the setting of redownload is OFF, content, which has been downloaded in the past and is cached, is used. “RSS CACHE TIME” stores a setting of a period of time for caching acquired RSS data. “ROUTINE NEWS HOLDING PERIOD” stores a setting of a period for storing a downloaded news content in the storage device 36. “HEADLINE NEWS SCROLL SPEED” stores a setting of a display speed of a headline displayed on the monitor 31, that is, a moving speed of the headline scroll-displayed in the monitor 31.

A description will be made by an example illustrated in FIG. 6. News, which has been already read, is not redownloaded. The RSS data is cached and held for three days. The downloaded news content is held as the content database 105 for ten days. The headline is displayed on the monitor 31 at a slow speed.

Next, a description will be made of a flow of a series of processes from acquiring of RSS data, downloading of content, and execution of a registered process with respect to the content in the above-described digital MFP 3.

First, a description will be made of a process relating to the first routine site table 101, i.e., a process for providing an index of updated content to a user. The RSS data control unit 34 refers to the first routine site table 101, and checks a presence or an absence of a site among the registered websites that has reached a routine timing. In case of a presence of a site which has reached the routine timing, the RSS data control unit 34 accesses the site and acquires RSS data.

When acquiring the RSS data, the RSS data control unit 34 carries out a data updating process with respect to the updated content table 103 based on the RSS data. Specifically, the RSS data control unit 34 adds information relating to the updated content described in the RSS data as a record of the updated content table 103. For example, when ten new news information is described in the RSS data, ten records are added to the updated content table 103.

Next, the content control unit 33 refers to the first routine site table 101 and the updated content table 103, and decides which content to download. That is, among data (records) registered in the updated content table 103, the content control unit 33 downloads content including a hit search keyword. For example, in case of the example illustrated in FIG. 3, for content updated information acquired from a site (http://aaaa/index.rdf) including a character string “standardization trend”, the content control unit 33 downloads content (i.e., not a title or abstract information included in the RSS data, but the content itself which is a data source). The content, which has been downloaded as described above, is converted into data in a prescribed saving format and stored as the content database 105 in the storage device 36.

A range of data to be downloaded is set in the first routine site table 101. In case of the example illustrated in FIG. 3, a setting of the range of the data to be downloaded is set for “VIDEO”, “IMAGE”, and “HTML”. Alternatively, a setting may also be made for voice data. A data format of contents to be stored in the content database 105 is also set in the first routine site table 101. For example, the contents are stored under an HTML format or a Portable Document Format (PDF) or the like. When a data format of downloaded content and a saving format of the data are different, the content control unit 33 converts the format of the data. For example, the content control unit 33 executes a process for converting HTML data into image data.

The content control unit 33 executes a process on the downloaded content according to the setting registered in the first routine site table 101. In case of the example illustrated in FIG. 3, when the print setting is set “ON”, a printing process is executed Alternatively, a process for forwarding the downloaded content to a remote terminal by electronic mail, a facsimile, or a File Transfer Protocol (FTP) or the like can be registered.

Accordingly, the digital MFP 3 executes a processing according to the setting stored in various tables of the storage device 36. Without requiring an operation of the user, the digital MFP 3 downloads necessary content, or downloads content and prints out the downloaded content. As a result, time and effort required for the users to individually gather contents can be omitted, and work efficiency improves. Since the downloaded contents are stored in the storage device 36 of the digital MFP 3 shared among the users, information can be efficiently shared by accessing the content database 105. Alternatively, when downloaded content is automatically printed out, the print-out is circulated or is placed under a viewable state at a prescribed location. As a result, information can be shared efficiently.

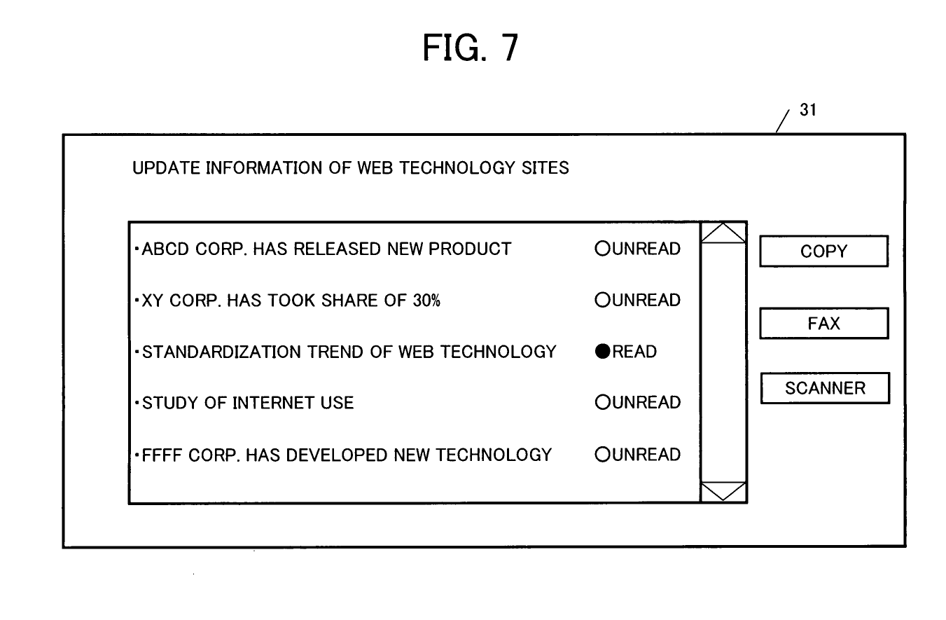

As illustrated in FIG. 7, the content control unit 33 includes a function for displaying the updated content table 103 on the monitor 31. For example, as illustrated in the drawing, the monitor 31 displays a list of a title of updated contents. Alternatively, the monitor 31 may display a title and a portion of a summary. A timing to display the list is not particularly limited. However, for example, the list may be displayed when the user touches the monitor 31, which is a touch screen display. Alternatively, a button for displaying the list may be provided, and when the user presses such a button, the monitor 31 may display the list.

When the user selects content from the list of the contents displayed on the monitor 31, in response to such a selection operation, the content control unit 33 accesses the web server 6 to download the content, which is the data source. For example, in case of the example illustrated in FIG. 7, when the user touches a character string of a title, the data source is downloaded. Alternatively, a separate download designation button may be provided. Accordingly, in addition to automatic download carried out by a search keyword, content, which has been selected manually by the user, can also be downloaded. The content downloaded in such a manner can also be stored in the storage device 36, and information can be shared. Alternatively, the user who has downloaded the content may print out, and circulate the content. When the user selects an interesting content from the contents displayed on the monitor 31, and when the selected content has already been downloaded, various processes (for example, a printing process, a forwarding process) are executed with respect to the cached content. That is, when content does not exist in the cache, the content is downloaded and various output processes are executed. When content exists in the cache, a process is executed for outputting the content from the cache.

As illustrated in the drawing, the content control unit 33 displays a flag with respect to content updated information displayed on the monitor 31 for indicating whether the content updated information is read or unread. An icon, etc. indicating “READ” is displayed for the content, which has been already downloaded automatically, and the content, which has been manually downloaded by another user. Therefore, other users do not download the same content again, and the content can be output promptly from the data in the cache. As a result, work efficiency is improved.

Next, a description will be made of a process relating to the second routine site table 102, i.e., a process for providing a headline of an updated content to a user. The RSS data control unit 34 refers to the second routine site table 102, and checks whether or not there is a site that has elapsed the update interval (a site which has reached the routine timing) among the registered websites. In case of a presence of a site that has elapsed the update interval, the RSS data control unit 34 accesses the site and acquires the RSS data.

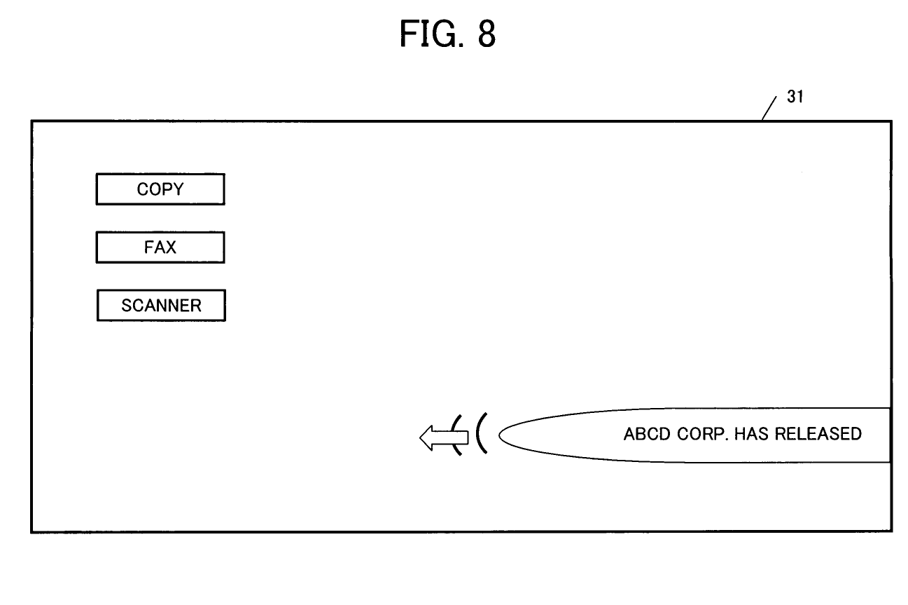

When acquiring the RSS data, the RSS data control unit 34 assigns the RSS data to the content control unit 33. The content control unit 33 extracts content updated information including the search keyword from the content updated information included in the RSS data. Then, the content control unit 33 displays the extracted content updated information on the monitor 31 as a headline. FIG. 8 illustrates a state in which the headline is displayed in a lower portion of the monitor 31. That is, since a search keyword is registered in the second routine site table 102 for each of the sites, when a search keyword registered with each site is included in the RSS data received from each site, the RSS data control unit 33 extracts the headline (an index) from the content updated information, and displays the extracted headline on the monitor 31. For example, as illustrated in the drawing, when the headline is displayed so as to flow from the right to the left in a display area within the monitor 31, people around the digital MFP 3 are called to attention. The title of the content included in the RSS data may be used for the character string to be displayed as the headline. Alternatively, a summary sentence may be run after the title. Further, the speed at which the headline is displayed may be adjusted by the “HEADLINE NEWS SCROLL SPEED” of the setting file 104.

Then, the user refers to the headline displayed on the monitor 31. When it is an interesting content for the user, the user touches the character string of the head line displayed on the monitor 31. Accordingly, the content control unit 33 downloads the content (i.e., the content itself that is the data source, and not the title or the summary information included in the RSS data). Alternatively, a separate button may be provided for designating download. The downloaded content is stored in the content database 105. Accordingly, the downloaded content can be shared among the users in the office 1.

In the above-described example, the updated content table 103 is not created from the RSS data acquired in accordance with the second routine site table 102, and only the headline is displayed. However, the updated content table 103 may be created.

As described above, according to the present preferred embodiment, the users are not required to individually gather or manage updated information of websites. The digital MFP 3 shared among the users manages the updated information, and automatically or manually downloaded contents are stored in the digital MFP 3. Alternatively, automatically acquired content is downloaded. Accordingly, employees working in the office 1 can efficiently share information. Data is not redundantly downloaded or printed out. As a result, work efficiency is improved, and resources can be saved.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A communication device, which is connected to a network and shared among a plurality of users, the communication device comprising:
a site database in which a routine timing is registered for each uniform resource locator of a website to be executed with routine;
an acquiring unit arranged to access the website under the routine timing registered with the site database, and acquires updated information data in which updated information regarding content of the website is described; and
a creating unit arranged to create an updated content database relating to updated content of the website from the updated information data.

2. The communication device according to claim 1, wherein the site database includes a keyword for each uniform resource locator, and the communication device further comprises a download unit which refers to the updated content database and the keyword, and downloads content from the website including updated information including the keyword.

3. The communication device according to claim 2, further comprising a setting unit which sets whether or not the content of the website including the updated information, which is registered in the updated content database, has been downloaded.

4. The communication device according to claim 3, further comprising a cache unit which caches the downloaded content,
wherein the setting unit sets whether or not to redownload the already downloaded content, and when the setting unit sets to not redownload, the cached content is used.

5. The communication device according to claim 2, wherein a process for the content can be registered in the site database, and the download unit processes the downloaded content according to the process registered with the site database.

6. The communication device according to claim 2, wherein a data type of data to be downloaded can be registered in the site database, and the download unit downloads only data corresponding to the registered data type among data constituting the content to be downloaded.

7. The communication device according to claim 2, wherein a saving format of the content to be downloaded can be registered in the site database, and the download unit stores the downloaded content under the registered saving format.

8. The communication device according to claim 1, wherein the updated information data is created in a resource description framework site summary format.

9. The communication device according to claim 1, further comprising:
a display unit which displays the updated information registered in the updated content database;
an operation unit arranged to be operated by a user to select desired information from the displayed updated information; and
a download unit which downloads content of a website including the selected updated information.

10. A communication device, which is connected to a network and shared among a plurality of users, the communication device comprising:
a site database in which a uniform resource locator of a website to be executed with routine and a routine timing are registered;
an acquiring unit which accesses the website under the routine timing registered in the site database, and acquires updated information data in which updated information regarding content of the website is described; and
a display unit which creates a headline relating to updated content of the website from the updated information data, and displays the headline in real-time.

11. The communication device according to claim 10, further comprising a download unit which downloads the content relating to the headline under a state in which the headline is displayed on the display unit.

12. A communication device, which is connected to a network and shared among a plurality of users, the communication device comprising:
a site database in which a routine timing is registered for each uniform resource locator of a website to be executed with routine;
an acquiring unit which accesses the website under the routine timing registered in the site database, and acquires updated information data in which updated information regarding content of the website is described;
a creating unit which creates an updated content database relating to updated content of the website from the updated information data; and
a download unit which downloads the content from the website based on the updated information data.
